(19) United States
(12) Patent Application Publication
(10) Pub. No.: US 2013/0016511 A1
(43) Pub. Date: Jan. 17, 2013

(54) COOLING FOR LED ILLUMINATION DEVICE

(71) Applicants: Matthew Arthur Mansfield, New South Wales (AU); James Richard Mansfield, New South Wales (AU)

(72) Inventors: Matthew Arthur Mansfield, New South Wales (AU); James Richard Mansfield, New South Wales (AU)

(21) Appl. No.: 13/261,126

(22) PCT Filed: Jul. 2, 2010
(86) PCT No.: PCT/AU2010/000849

§ 371 Date: Sep. 25, 2012

(30) Foreign Application Priority Data
Jul. 2, 2009 (AU) 2009903089

(51) Int. Cl. F21V 29/00; F21V 5/04

(52) U.S. Cl. 362/244

(57) ABSTRACT

An LED illumination device comprising a lens assembly, a circuit board having at least one LED and a housing to retain said circuit board and said lens assembly, and wherein said circuit board comprises a plurality of pores adjacent said at least one LED to facilitate airflow over a large surface area of said circuit board in the vicinity of said at least one LED.

### FIELD OF THE INVENTION

The present invention relates to the field of lighting and lighting devices. More particularly, this invention relates to an improved LED illumination device.

### BACKGROUND OF THE INVENTION

Light-emitting diodes (LEDs) are commonly used as light sources for a range of automobile, industrial and domestic applications. They provide a number of advantages over more traditional light sources, such as incandescent bulbs, including lower energy consumption, smaller size, faster switching and greater operational lifetime.

The development of higher power LEDs has improved the quality of white light offered by these devices but the resulting higher junction temperatures and current densities lead to increased heat production which can lead to device failure. Thermal management of LED devices has thus become a critical issue for consideration in terms of their reliability and operational lifetime.

There are a number of existing cooling means to manage the heat production from LEDs including the use of external fans and heat sinks. Fans help maintain the LED at a reasonable working temperature of up to 70° C. by forcing a positive air stream over the LED housing thereby helping to dissipate heat. This can be a reasonably effective means of thermal management but results in additional expense for the consumer both in terms of the initial purchase and ongoing power usage. The use of a fan also greatly increases the bulk of the device which makes it unsuitable for applications in limited space environments.

Heat sinks feature in the thermal management of many electronic devices, including LED lighting devices, and can be useful in absorbing at least a portion of the heat from the LED and dissipating it into the atmosphere. However, conventional thin fin heat sinks are often unable to dissipate enough heat to maintain an LED at an acceptable operating temperature thus resulting in early failure or necessitating operational limitations be imposed on the device.

The above described measures all contribute to improving the reliability and typical lifetime of LED lighting devices but further improvements in this area, as well as in terms of optical properties and energy efficiency, could see their adoption become even more widespread and provide further benefits to the consumer.

### OBJECT OF THE INVENTION

It is therefore an object of the invention to overcome or alleviate at least one of the aforementioned deficiencies in the prior art or at least provide a useful or commercially attractive alternative.

### SUMMARY OF THE INVENTION

In one form, although it need not be the only or indeed the broadest form, the invention resides in an LED illumination device comprising:
(a) a lens assembly;
(b) a circuit board located beneath said lens assembly, said circuit board comprising at least one LED; and
(c) a housing to retain said lens assembly and said circuit board,

wherein, said circuit board comprises a plurality of pores adjacent said at least one LED.

Suitably, said plurality of pores substantially surrounds said at least one LED.

Preferably, said housing comprises a heat transfer face located beneath said circuit board.

In a preferred form, said LED device further comprises an interface layer located between said circuit board and said heat transfer face of said housing.

Preferably, said interface layer is heat conductive.

If required, said interface layer may also be electrically insulating.

Suitably, said interface layer is a filled thermally conductive polymer on a rubber coated fiberglass carrier.

Preferably, said housing is adapted to function as a heat sink for said LED illumination device.

In one particularly preferred form, a body of said housing comprises a plurality of elongate fins extending away from a lower surface of said heat transfer face.

Preferably, said elongate fins form a branching pattern at their outer extent.

The arrangement of said elongate fins defines a plurality of open channels within said body of said housing.

Suitably, said circuit board, said interface layer and said heat transfer face of said housing are provided with aligned apertures which are in open communication with said open channels.

Preferably, said lens assembly comprises one or more raised portions, in the form of convex optical bodies, on an upper surface thereof which are substantially aligned with said LEDs.

Suitably, said lens assembly comprises one or more lens apertures.

Therefore, in a particularly preferred embodiment the invention resides in an LED illumination device comprising:
(a) a lens assembly having an upper face and a lower face, said upper face having one or more convex optical bodies;
(b) a circuit board located adjacent said lower face of said lens assembly, said circuit board comprising at least one LED;
(c) a housing to retain said lens assembly and said circuit board, said housing having a body and a heat transfer face, said heat transfer face located beneath said circuit board and said body comprising a plurality of elongate fins extending away from a lower surface of said heat transfer face; and
(d) a heat conductive interface layer located between and in thermal communication with said circuit board and said heat transfer face of said housing;

wherein, said circuit board comprises a plurality of pores adjacent said one or more LEDs.

Preferably, said circuit board, said interface layer and said heat transfer face of said housing are provided with aligned apertures which define a flow path for air through said LED illumination device.

A circuit board comprising a plurality of LEDs wherein each LED is substantially surrounded by a plurality of pores located adjacent said LED.

Preferably, said plurality of pores substantially surrounds said LED.

Further features of the present invention will become apparent from the following detailed description.

Throughout this specification, unless the context requires otherwise, the words “comprise”, “comprises” and “comprising” will be understood to imply the inclusion of a stated integer or group of integers but not the exclusion of any other integer or group of integers.

### BRIEF DESCRIPTION OF THE FIGURES

In order that the invention may be readily understood and put into practical effect, preferred embodiments will now be described by way of example with reference to the accompanying figures wherein like reference numerals refer to like parts and wherein:

FIG. 1 shows a perspective view of an LED illumination device, according to an embodiment of the invention, and an associated retainer clip;

FIG. 2 shows an exploded view of the LED illumination device and associated retainer clip shown in FIG. 1;

FIG. 3 shows a perspective view of the underside of part of the LED illumination device shown in FIG. 2; and

FIG. 4 shows a plan view of part of the circuit board component of the LED illumination device shown in FIG. 2.

### DETAILED DESCRIPTION OF THE INVENTION

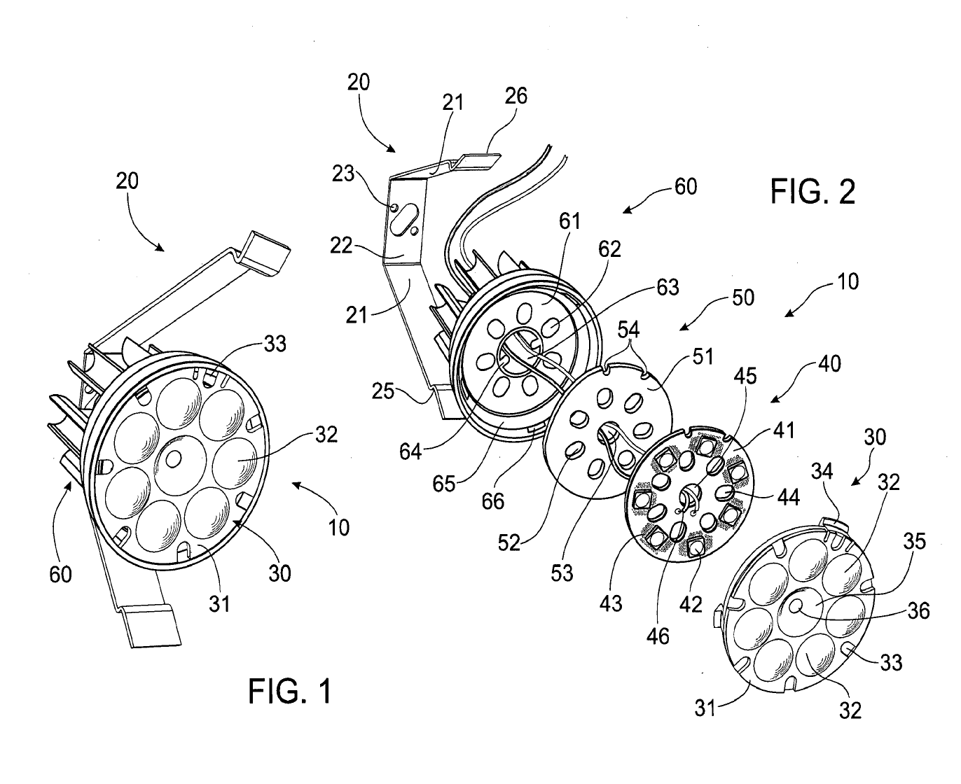

FIG. 1 shows a perspective view of an LED illumination device 10, according to an embodiment of the invention, and an associated retainer clip 20. LED illumination device 10 sits within and is affixed to retainer clip 20. LED illumination device 10 comprises a lens assembly 30 having an upper face 31 upon which are provided raised portions 32, in the form of discrete convex bodies. The convex bodies shown in the embodiment in the figures are circular/spherical but other shapes may be suitable. These convex bodies are optics which are designed to align with the LEDs to enhance emitted light quality. Lens assembly 30 is located within housing 60 which in turn is in contact at its lower extent with retainer clip 20.

FIG. 2 shows an exploded view of LED illumination device 10 and associated retainer clip 20 shown in FIG. 1. Retainer clip 20 comprises arms 21 and base 22 which has screw holes 23 and aperture 24 formed therein. Arms 21 have kink 25 formed therein, end in angled portion 26 and are designed to releasably engage with LED illumination device 10. Retainer clip 20 does not form part of the invention but is shown for the sake of clarity.

Lens assembly 30 can be seen to have peripheral lens apertures 33 formed in and dispersed around the circumference of upper face 31. These peripheral lens apertures 33, along with a more centrally located aperture discussed below, enable efficient airflow into LED illumination device 10. One or more clips 34 extend from lens assembly 30 around its periphery and a central depression 35 and central lens aperture 36 are also provided in upper face 31 of lens assembly 30. Clips 34 will be located within housing recesses 66 to hold lens assembly 30 in place within housing 60.

Circuit board 40 is located beneath lens assembly 30 and, in the embodiment shown, comprises an upper face 41 with seven surface mounted LEDs 42 arranged in a radial fashion. Each LED 42 is shown with a square border and is surrounded on three sides thereof by an arrangement of pores 43. It will be appreciated that pores 43 may be formed in circuit board 40 adjacent one or more portions of a border or circumference of LEDs 42 or LEDs 42 may be substantially surrounded by pores 43. By ‘substantially surrounded’ it is envisaged that pores 43 may surround at least 60%, 70%, 80%, 90%, 95% or 100% of an outer surface, border or periphery of each of LEDs 42. Pores 43 are through holes, i.e. they extend from upper face 41 of circuit board 40 through to the lower face thereof, and thereby enable air to flow through circuit board 40 in the region closest to LEDs 42 which will, during operation, represent the hottest areas of circuit board 40. In the embodiment shown pores 43 are lined with copper in keeping with the backing of circuit board 40. Pores 43 should, therefore, be unobstructed throughout their length through the body of circuit board 40.

As air flows through pores 43 it will be in contact with a larger surface area of circuit board 40 than would otherwise have been available. This results in heat being very effectively dissipated from those areas and thus efficiently cools LEDs 42. The heat may be carried away by the airflow or at least will be transferred to the lower surface of circuit board 40 adjacent an interface layer 50 into which the heat can then pass by conduction. Pores 43 open at their lower extent into interface layer 50. Moving air can still flow around this layer 50 or diffuse through it to escape LED illumination device 10. Interface layer 50 is designed to accept heat from circuit board 40 and so pores 43 ending in this layer is actually an advantage as heat is drawn to the bottom of circuit board 40 by the passage of air and is then more effectively transported into interface layer 50 and hence the heat sink that is housing 60.

The actual arrangement of pores 43 can have an effect on the efficiency of thermal management. In general, pores 43 may be presented in clusters surrounding LEDs 42 which enable the maximum number of pores 43 to be placed as closely as possible to LEDs 42. In the arrangement shown in the figures, pores 43 are formed in somewhat pyramid shaped clusters. The greater number of pores per row are placed directly adjacent LEDs 42, where they will have the maximum effect, and in moving further away from the border of LEDs 42 their number in each row decreases. The actual diameter of each pore 43 is important. Small diameter pores 43 greatly increase the surface area of circuit board 40 presented to the passage of air and are more effective than a smaller number of larger diameter holes. The diameter of pores 43 must therefore be sufficient to allow enough air to pass through per unit time to result in the desired cooling effect. In one embodiment the diameter of pores 43 is less than 5 mm, preferably less than 4 mm, more preferably less than 3 mm, even more preferably less than 2 mm or more preferably yet less than 1 mm. There may be greater than ten pores 43 adjacent each LED 42, preferably greater than twenty, more preferably greater than 30.

In one particular embodiment the invention resides in a circuit board 40 comprising at least one LED 42 wherein each LED 42 is substantially surrounded by a plurality of pores 43 located adjacent said LED 42. It will be appreciated therefore that the region of circuit board 40 immediately adjacent LEDs 42 is not continuous due to pores 43 and so the surface area of circuit board 40 exposed to air will be greater than if circuit board 40 was a solid plate without any through holes.

Circuit board radial apertures 44 are located between adjacent LEDs 42. Central circuit board aperture 45 has power connections 46 extending there through and connecting with the upper face 41 of circuit board 40. Circuit board radial apertures 44 and central circuit board aperture 45 both allow air flow through circuit board 40 but are functionally somewhat different from pores 43. While pores 43 are designed to maximise the heat dissipation surface area in the vicinity of LEDs 42, circuit board radial apertures 44 and central circuit board aperture 45 facilitate the bulk movement or flow of air through LED illumination device 10. Looked at another way, the volume of air which can pass through each pore 43 per unit time is therefore considerably less than that which can pass through a circuit board radial aperture 44 but the larger numbers of pores 43 concentrated in the vicinity of LEDs 42 ensures adequate air flow in those hot spots. Circuit board radial apertures 44 and central circuit board aperture 45 are thus magnitudes of order larger in terms of their diameter than pores 43. Air which enters LED illumination device 10 through peripheral lens apertures 33 can pass through circuit board radial apertures 44 and central circuit board aperture 45 thus aiding the bulk movement of air and assisting with dissipating heat from circuit board 40, generally, rather than specifically at the site of LEDs 42 as is the case with pores 43.

In a further embodiment the invention resides in a circuit board 40 comprising a plurality of LEDs 42 wherein each LED 42 is substantially surrounded by a plurality of pores 43 located adjacent said LED 42 and wherein said circuit board 40 further comprises an aperture 44 located between adjacent LEDs 42 and wherein the diameter of said pores 43 is less than the diameter of said apertures 44.

Interface layer 50 has an upper surface 51 which, in use, is in contact with the underside of circuit board 40 on which there are no LEDs 42. Interface layer 50 has a plurality of interface layer radial apertures 52 formed therein and distributed around a central interface layer aperture 53. Alignment sections 54 are provided at two points on the periphery of interface layer 50 to assist with the alignment of housing radial apertures 62, formed in housing 60, with interface layer radial apertures 52 and circuit board radial apertures 44. Interface layer radial apertures 52 thus align with circuit board radial apertures 44 and central interface layer aperture 53 aligns with central circuit board aperture 45 to define a series of air flow pathways. Alignment sections 54 also indirectly aid in aligning LEDs 42 with raised portions 32 of lens assembly 30. Interface layer 50 may be made from any material which is a good thermal conductor but also an electrical insulator such as a filled thermally conductive polymer.

Housing 60 can be seen from FIG. 2 to have a body comprising a heat transfer face 61 which is located beneath interface layer 50 and is in thermal contact with the underside thereof. Housing radial apertures 62, formed in heat transfer face 61, are distributed around central channel 63 which is generally of a greater diameter than interface layer aperture 53 or central circuit board aperture 45. Elongate projections 64 protrude into central channel 63 and extend along its length thereby increasing the surface area of its walls. The periphery of heat transfer face 61 is continuous with rim 65 which has housing recesses 66 formed therein.

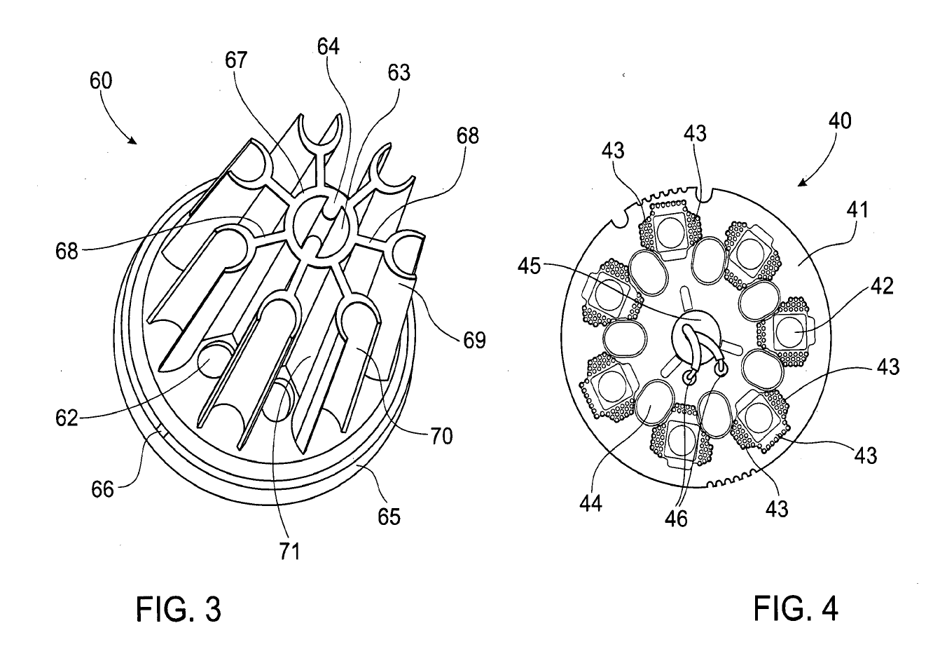

FIG. 3 shows a perspective view of the underside of part of the LED illumination device 10 shown in FIG. 2. The portion of the body of housing 60 located beneath and extending from the underside of heat transfer face 61 (extending away from interface layer 50) is now apparent. Central channel 63 and elongate projections 64 are defined by central wall 67 which is continuous with elongate fins 68 which extend radially therefrom. Each elongate fin 68 ends in a branch 69 at its outer extent which curves outwardly, in a goblet shaped terminal arrangement, to define grooves 70. Fin channels 71 are formed between adjacent elongate fins 68 and are continuous with housing radial apertures 62.

FIG. 4 shows a plan view of part of the circuit board component of LED illumination device 10 shown in FIG. 2. Circuit board 40 is seen in greater detail and the particular layout of pores 43, as discussed above, is apparent. Circuit board 40 may be manufactured from a range of materials which are well known in the art such as a green silicone board with a copper layer laminated on its underside. Copper can provide advantages in terms of thermal transference; however, a range of other materials, including metals such as aluminium, may be acceptable. Preferably, circuit board 40 comprises copper or aluminium.

In the embodiment shown each LED 42 is surrounded on three sides by the material forming the upper surface of circuit board 40, typically aluminium or copper, with pores 43 formed therein. Pores 43 are themselves lined with the aluminium or copper or, preferably, are continuous with the circuit board 40 upper surface metal layer and are distributed around the LEDs 42 in a pattern such that a maximum number of pores are accommodated within the available space.

In use, interface layer 50 sits with its lower surface in contact with heat transfer face 61 of housing 60 and its upper surface 51 in contact with the lower face of circuit board 40. The circuit board radial apertures 44, interface layer radial apertures 52 and housing radial apertures 62 are all of substantially the same shape and size and are in alignment to form a plurality of air passages which are substantially coterminous with fin channels 71. Similarly, the central lens aperture 36, central circuit board aperture 45, central interface layer aperture 53 and central channel 63 of housing 60 are all in alignment and allow the passage of the power connections 46 as well as forming an efficient bulk air flow passage. Lens assembly 30 is located above the upper face 41 of circuit board 40 and is held in place within housing 60 by clips 34 which extend into housing recesses 66 of housing 60. Individual raised portions 32 of upper face 31 of lens assembly 30 are in alignment with an LED 42 on circuit board 40. The lens assembly 30, circuit board 40 and interface layer 50 are substantially located within the border formed by rim 65 of housing 60.

The present invention provides a combination of features which is not seen in the prior art and presents a number of advantages as a result. One of the greatest problems with the use of LED lights is that of proper thermal management to improve stability and reduce failure rate. The present invention addresses this issue in a number of ways which have been mentioned above.

In use, the arrangement of peripheral lens apertures 33 and central lens aperture 36 allows cool air to enter LED illumination device 10 and pass over LEDs 42 and circuit board 40, generally, to help control the device temperature. The air is then able to pass all the way through LED illumination device 10 via aligned apertures 44, 52 and 62. As the air passes through it is heated up and, in turn, cools the components of LED illumination device 10.

Importantly, the plurality of pores 43 surrounding each LED 42 allow the passage of a maximal volume of air close to the vicinity of LEDs 42, being the heat source. The number and arrangement of pores 43 is such that the surface area of circuit board 40 presented to the air stream for cooling is greatly increased, thereby resulting in improved temperature regulation and increased lifetime of LED illumination device 10. The particular arrangement and number of pores 43 shown in FIG. 4 have been designed to maximise the cooling effect. Pores 43 may be formed by a number of means which would be known to a person of skill in the art. By way of non-limiting example only, pores 43 may be punched or drilled into the formed circuit board 40 or, alternatively, may be integrally formed during manufacture of said circuit board 40.

As previously described, circuit board 40 is in contact with interface layer 50 which may be made from any material which is a good thermal conductor but also an electrical insulator. As well as the cooling effect achieved by the moving air, as discussed above, the heat contained within circuit board 40 is also physically conducted away into interface layer 50 which in turn enables the heat energy to be transferred to heat transfer face 61 and into a heat sink which, conveniently, is the body of housing 60, generally, where it can be effectively dissipated by the arrangement of elongate projections 64 and elongate fins 68. Interface layer 50 may be manufactured from a range of materials which are known to be good thermal conductors but electrical insulators. By way of example only, such thermally conductive interface pads may be purchased from commercially available sources such as 3M (http://solutions.3m.com/wps/porta1/3M/en_WW/About3/3M/) ort-global technology (http://www.tglobal.com.tw/en/index.php).

Interface layer 50 may be a filled thermally conductive polymer. Preferably, interface layer 50 is a filled thermally conductive polymer laid on a rubber coated fibreglass carrier; such as the Gap Pad VO thermally conductive interface commercially available from Bergquist (http://www.bergquistcompany.com/index.htm).

Housing 60 also performs the role of a heat sink for LED illumination device 10. It is one advantage of the present invention that a separate heat sink, which can greatly increase the bulk and cost of the device, is thereby unnecessary. In this manner the heat generated by LEDs 42 is passed from interface layer 50 into housing 60 and heats up all of the components of said housing, including elongate projections 64, central wall 67 and elongate fins 68.

The design of housing 60 is such that the exposure of its various components to passing air has been optimised. Elongate fins 68 extend radially away from LED illumination device 10 and branch at their outer extent to form a preferred goblet shape and maximise the exposed surface area. Housing radial apertures 62 extend from heat transfer face 61 through the body of housing 60 to draw air through the body and then direct it along the inner surface of fin channels 71. The number of housing radial apertures 62 in combination with central channel 63 means a relatively large amount of air can be drawn through LED illumination device 10 per unit time and a high proportion of housing 60 is exposed to this air flow. An optimal working temperature range for an LED illuminating device of the present kind is between about 50° C. to 70° C. and 4 hour testing runs of LED illumination device 10 have shown that the combination of thermal management features described herein achieves a stable working temperature of around 58° C. This represents a sufficiently low figure such that there is room for this to rise even if LED illumination device 10 is fitted, for example, within a ceiling installation where insulation can restrict airflow.

The lens assembly 30 of LED illumination device 10 also provides certain advantages over the prior art in terms of the efficient production of visually pleasing white light. The design of LED illumination device 10, in the embodiment shown, enables seven LED clusters to be incorporated. LEDs 42 employ a combination of blue diodes with an orange filter which, in combination with the optical effect of convex bodies 32, enables the production of white light which is particularly pure to the eye. Raised portions 32 of lens assembly 30 have a convex shape which varies in size and thickness and is designed to provide optimal light intensity for a given light spread range. Different raised portions 32 can be provided for, e.g., 15, 25, 38 & 60 degree light spreads.

LED illuminating device 10 provides improved efficiency over comparable halogen light devices. An efficiency gain can be obtained equivalent to 35 W halogen performance with 7 W of actual usage. Further, a particular advantage of one embodiment of the present invention is that there is limited degradation of light intensity given the 7 W power. The lens assembly 30, including raised portions 32, enables the intensity of the LEDs to be optimal and limits the performance reduction to maintain the full lumens with 7 W of power.

It will be appreciated that LED illumination device 10 provides a combination of features which result in the particular advantages of improved thermal management, in turn leading to increased stability and operational lifetime, and visually pleasing white light. The design of the various components is such that air is drawn in to the device 10 and is directed over a maximal exposed surface area of circuit board 40, interface layer 50 and housing 60 to aid in heat dissipation and maintain a desirably low working temperature. The central apertures 36, 45, 53 and 63 allow for the relatively fast passage of bulk airflow to cool circuit board 40 generally by transferring heat away to where it can best be dissipated. Pores 43 allow for a more directed air flow adjacent the actual LEDs 42 to maximize cooling at the hottest areas of circuit board 40 and, importantly, cool LEDs 42 themselves to help increase their operational lifetime. The heat generated within LEDs 42 is drawn down to the bottom of circuit board 40 and into interface layer 50 by the action of air passing through pores 43. This combination of air flow passages in conjunction with the more general conduction of heat from circuit board 40 into interface layer 50 due to them being in contact, allows for greatly improved thermal management of LED illumination device 10.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

1. An LED illumination device comprising:
(a) a lens assembly
(b) a circuit board located beneath said lens assembly, said circuit board comprising at least one LED; and
(c) a housing to retain said lens assembly and said circuit board, wherein, said circuit board comprises a plurality of pores adjacent said at least one LED.

2. The LED illumination device of claim 1 wherein said plurality of pores substantially surrounds said at least one LED.

3. The LED illumination device of claim 1 wherein said housing comprises a heat transfer face located beneath said circuit board.

4. The LED illumination device of claim 3 further comprising a heat transport interface layer located between said circuit board and said heat transfer face.

5. The LED illumination device of claim 4 wherein said interface layer is heat conductive and electrically insulating.

6. The LED illumination device of claim 4 wherein said interface layer is a filled thermally conductive polymer.

7. The LED illumination device of claim 6 wherein said interface layer is a filled thermally conductive polymer on a rubber coated fiberglass carrier.

8. The LED illumination device of claim 1 wherein a body of said housing is adapted to function as a heat sink.

9. The LED illumination device of claim 1 wherein said housing comprises a plurality of elongate fins extending away from said heat transfer face and said circuit board.

10. The LED illumination device of claim 9 wherein said elongate fins form a branching pattern at their outer extent.

11. The LED illumination device of claim 9 wherein adjacent elongate fins define an airflow channel.

12. The LED illumination device of claim 4 wherein said circuit board, said interface layer and said heat transfer face of said housing are provided with aligned apertures which define a flow path for air through said LED illumination device.

13. The LED illumination device of claim 12 wherein the aligned apertures are in open communication with said airflow channels.

14. The LED illumination device of claim 1 wherein said lens assembly comprises at least one convex optical body formed on an upper surface thereof.

15. The LED illumination device of claim 14 wherein said convex optical body is substantially aligned with said LED.

16. The LED illumination device of claim 1 wherein said lens assembly comprises at least one lens aperture.

17. The LED illumination device of claim 16 wherein said lens assembly comprises a plurality of lens apertures disposed around a periphery thereof.

18. The LED illumination device of claim 17 further comprising a centrally located lens aperture.

19. An LED illumination device comprising:
(a) a lens assembly having an upper face and a lower face, said upper face having one or more convex optical bodies;
(b) a circuit board located adjacent said lower face of said lens assembly, said circuit board comprising at least one LED;
(c) a housing to retain said lens assembly and said circuit board, said housing having a body and a heat transfer face, said heat transfer face located beneath said circuit board and said body comprising a plurality of elongate fins extending away from a lower surface of said heat transfer face; and
(d) a heat conductive interface layer located between and in thermal communication with said circuit board and said heat transfer face of said housing,
wherein, said circuit board comprises a plurality of pores adjacent said at least one LED.

20. The LED illumination device of claim 19 wherein said plurality of pores substantially surrounds said at least one LED.

21. The LED illumination device of claim 19 wherein said convex optical bodies are substantially aligned with said LEDs.

22. The LED illumination device of claim 19 wherein said interface layer is electrically insulating.

23. The LED illumination device of claim 19 wherein said circuit board, said interface layer and said heat transfer face of said housing are provided with aligned apertures which define a flow path for air through said LED illumination device.

24. The LED illumination device of claim 19 wherein said lens assembly comprises at least one lens aperture.

25-29. (canceled)
